(19) United States
(12) Patent Application Publication
(10) Pub. No.: US 2025/0284334 A1
(43) Pub. Date: Sep. 11, 2025

(54) HUMAN-MACHINE INTERFACE SYSTEM

(71) Applicant: All Virtual, Versailles (FR)

(72) Inventor: Eric Belmon, Corbeil-Essones (FR)

(21) Appl. No.: 18/695,061

(22) PCT Filed: Sep. 23, 2022
(86) PCT No.: PCT/EP2022/076525

§ 371 Date: Aug. 28, 2024

(30) Foreign Application Priority Data
Sep. 27, 2021 (FR) 2110175
Feb. 21, 2022 (FR) 2201517

(51) Int. Cl. G06F 3/01; G06F 3/0482

(52) U.S. Cl. CPC G06F 3/013; G06F 3/012; G06F 3/0482

(57) ABSTRACT

A human-machine interface system includes at least one visual interaction device having image-capturing means and display means and computerized means executing an interface allowing a user to interact with the visual interaction device. The system presenting the user with an at least partially virtual content item, in particular, for augmented reality, the interaction device capturing the real environment of the user to provide it to the interface, which generates a mesh of the environment and tracks the user's gaze, the interface being configured to detect when the user's gaze is oriented toward the ground and to start a launcher that is presented to the user via the interaction device in the form of at least one navigation content item including a plurality of graphical elements that the user is able to scroll through with their gaze and that are representative of a function to which they correspond.

### CROSS-REFERENCE TO RELATED APPLICATIONS

This application is a national phase entry under 35 U.S.C. § 371 of International Patent Application PCT/EP2022/076525, filed Sep. 23, 2022, designating the United States of America and published as International Patent Publication WO 2023/046902 A1 on Mar. 30, 2023, which claims the benefit under Article 8 of the Patent Cooperation Treaty of French Patent Application Serial No. FR2110175, filed Sep. 27, 2021, and French Patent Application Serial No. FR2201517 filed Feb. 21, 2022.

### TECHNICAL FIELD

The present disclosure relates to a human-machine interface system (HM) and more precisely a virtual interaction device (DI).

### BACKGROUND

Advances in information, image and multimedia technologies have led to the development of virtual reality (VR) and augmented reality (AR) systems and devices, wherein digitally produced images, graphics or objects are presented to a user in such a way that they may be perceived as real.

In the current state of the art, there are several systems and devices that enable a user to interact to a greater or lesser extent with the virtual environment produced by the systems and devices, as well as with the elements or objects found therein.

However, the interaction systems or devices (DI) and interfaces known to date often have a number of drawbacks, particularly in terms of ergonomics, reliability, remote collaboration, and the computing resources involved. Indeed, with regard to ergonomics, known solutions often do not allow the user to perform movements in an intuitive and precise manner. In addition, regarding reliability, the reliability of known solutions for user interaction with the system depends enormously on the external actual environment wherein the user is located. On the other hand, when it comes to remote collaboration, known solutions often do not allow for efficient dynamic evolution of the displayed virtual environment, or are not adapted to sharing data with other interaction devices or systems (DI) directly present in the same external or remote real environment. All these disadvantages are generally accompanied by a problem of computing resources for the devices and systems, as existing solutions are too resource-intensive, with inefficient and/or unreliable results.

### BRIEF SUMMARY

The purpose of the present disclosure is to overcome certain disadvantages of the prior art by offering a system that improves human-machine interaction.

This goal is achieved by a human-machine interface system, comprising at least one visual interaction device (DI), comprising image-capturing means and display means, and computerized means comprising at least one processor running an interface for user interaction with the visual interaction device (DI), the system presenting the user with an at least partially virtual content item, in particular, for augmented reality, the interaction device (DI) capturing the real environment of the user in order to provide it to the interface, which generates a mesh of the environment and tracks the user's gaze, the interface being characterized in that it is configured to detect when the user's gaze is oriented towards the ground and, following this detection, to start a launcher that is presented to the user via the interaction device (DI) in the form of at least one navigation content item comprising a plurality of graphical elements that the user is able to scroll through with their gaze and that are representative of a function to which they correspond, the interface detecting the movement of the user's gaze across these graphical elements (11), and, when the user's gaze has come to rest on one of these graphical elements for a given duration, the launcher selects this graphical element and triggers the function to which it corresponds, the set of available functions comprising at least:
a) the execution of an application available via the interface and executable on the interaction device (DI);
b) the opening of at least one content item or document stored in storage means (e.g., a non-transitory computer-readable storage device) accessible via the interface; and
c) the deployment of other graphical elements in the launcher, across which the user can move their gaze in order to trigger the same functions a), b) or c) when it comes to rest thereupon for the determined duration.

According to another feature, the navigation content item, comprising the plurality of graphical elements, comprises at least one ring displayed on the floor centered around the user, the plurality of graphical elements being distributed angularly on the ring, one next to the other.

According to another particular feature, when the user has come to rest on a graphical element corresponding to a deployment function c), within a navigation content item, called the parent, the launcher displays another navigation content item, called the child, dependent on the parent content item and comprising a second ring, preferably concentric to the first ring, or a line, preferably radial to the first ring, and comprising at least one other graphical element also corresponding to one of the functions a), b) or c), potentially with a plurality of repetitions of parent-child navigation content items of successive generations.

According to another particular feature, when the user is scrolling through a child navigation content item without coming to rest on one of the graphical elements that it contains and moves their gaze to a parent navigation content item on which it depends, potentially across a plurality of parent-child generations, the launcher, after a determined time period, withdraws the child content item(s) by canceling their display(s) on the interaction device (DI) and displays only the parent navigation content item on which the user is fixing their gaze.

According to another feature, the interface proposes to the user, via the launcher, navigation content items that are contextual, taking into account the environment of the user and/or a context wherein the user is located, the interface determining the context by virtue of the interaction device (DI) or any other device carried by the user and connected to the interface, providing it with information used by the interface, among at least:
receiving images captured by the interaction device (DI), optionally with image recognition and/or detection of electronic codes (barcode, QR codes, etc.); geolocation;
detecting various physical values by various types of sensors; and
receiving information provided by connected objects present in the environment of the user and able to communicate with the computerized means executing the interface.

According to another feature, the interface is configured to define at least one list of applications and/or content items or documents to be displayed, in particular, as a function of the environment wherein the user is located, the list of applications and/or content items or documents potentially being updated on request from the user via the selection of a dedicated graphical element when they are not part of the selection displayed by the interface, in order to obtain a wider set of functions, the interaction device (DI) then loading in memory the data necessary for this update.

According to another feature, the interaction device (DI) is configured to update the interface, with the user's selection of an element dedicated to this update triggering the connection and synchronization of the interaction device (DI) to computerized means containing a set of parameters, applications, content items or documents loadable into memory by the interaction device (DI) in order to render the latter and the interface compatible with the immediate needs of the user.

According to another feature, the system comprises a plurality of interaction devices (DI) connected to each other, preferably securely to form a shared device cluster, at least one of these interaction devices (DI) being configured to share by transmission instructions relating to content items to be displayed on the interface of the other devices depending on the actions carried out via the interface, so that all of the interaction devices (DI) display the same elements as a result of actions or selections performed via the interface of the interaction device (DI).

According to another feature, the plurality of visual interaction devices (DI) each comprises image-capturing means and display means and computerized means comprising at least one processor running an interface for user interaction with the visual interaction device (DI), the system presenting the user with an at least partially virtual content item, in particular, for virtual reality and/or augmented reality, the interaction device (DI) capturing the real environment of the user in order to provide it to the interface, which generates a mesh of the environment and tracks the user's gaze, the interface being connected to each of the users' visual interaction devices (DI) to enable them to share data with each other via the computerized means and display content to them, which is synchronized on the various securely communicating visual interaction devices (DI), the system comprising means for storing data containing objects, documents and 3D maps (maps of virtual environments established from real environments and representative of maps of real sites or places previously recorded with various levels of detail as to their topography and/or their geolocation and/or various technical information relating to the physical elements present in these sites or places), the interface being configured to track the actions of each of the users in the virtual environment thus presented to the users of the communicating devices to which the interface proposes a set of content items, objects, or documents sharable with the users, so that the tracking of their respective actions enables them to place these various content items, objects or documents within the virtual environment, the system also being connected to at least one sensor or communicating device of a user present within the real environment thus simulated in order to provide the interface, in real time or predicted according to a schedule, with information relating to the physical parameters measured in real time in the real environment or predicted for a later time or date, in order to provide the users of the communicating devices with the actual physical information present or predictable within the real environment.

The disclosure also relates to a method of interaction between a user and computerized means by virtue of a visual interaction device (DI).

According to another feature, the method comprises an execution on the computerized means of a human-machine interface of a system according to the disclosure.

### BRIEF DESCRIPTION OF THE DRAWINGS

Other features, details and advantages of embodiments of the disclosure will become apparent from reading the following description with reference to the appended figures, in which:

FIG. 1 is a schematic representation of the launcher of the interaction device according to one embodiment;

FIG. 2 is a schematic representation of the launcher;

FIG. 3 is a schematic representation of the use of the interaction device according to one embodiment;

FIG. 4 is a schematic representation of a set of interaction devices communicating with one another via a network, according to one embodiment;

FIG. 5 is a schematic representation of the launcher, according to one embodiment;

FIG. 6 is a schematic representation of a “device information” element of the launcher, according to one embodiment;

FIG. 7 is a schematic representation of a “category button” element of the launcher, according to one embodiment;

FIG. 8 is a schematic representation of a “child category button” element of the launcher, according to one embodiment;

FIG. 9 is a schematic representation of a “Child Category 2 button” element of the launcher, according to one embodiment;

FIG. 10 is a schematic representation of a “Ring Back button” element of the launcher, according to one embodiment;

FIG. 11 is a schematic representation of a “Ring Up button” element of the launcher, according to one embodiment;

FIG. 12A is a schematic representation of a “Scroll button” element of the launcher with a left arrow, according to one embodiment;

FIG. 12B is a schematic representation of a “Scroll button” element of the launcher with a right arrow, according to one embodiment

### DETAILED DESCRIPTION

Many combinations may be envisaged without departing from the scope of the disclosure; a person skilled in the art will select one according to the economic, ergonomic, dimensional or other constraints that they have to observe.

In general, the present disclosure relates to a human-machine interface system comprising at least one visual interaction device (DI), comprising image-capturing means and display means. The visual interaction device (DI) will be conventionally a headset or glasses, in particular, for augmented reality (AR). However, the disclosure also applies to virtual reality, for which the functionalities offered by the present disclosure remain advantageous, notably thanks to the ease with which the user can navigate within the environment (real, augmented or virtual) The visual interaction device (DI) further comprises computerized means comprising at least one processor executing an interface for the interaction of a user with the visual interaction device (DI).

The system presents the user with an at least partially virtual content item, in particular, for augmented reality. The interaction device (DI) captures the real environment of the user to provide it to the interface executed by the processor of the visual interaction device (DI). The interface generates a mesh of the environment and tracks the user's gaze.

The person skilled in the art will understand that the interaction device (DI) can thus be provided with sensors, for example, cameras, making it possible to capture images of the environment and at least one program, stored in the computerized means, and whose execution on the processor of the computerized means makes it possible to calculate a mesh from the captured images of the environment.

The term “gaze” refers, in the present application, to the orientation of the user's head or line of sight, optionally with real monitoring of the eyes, for example, by techniques known from the prior art that do not need to be specified here. Likewise, it is not necessary here to detail the techniques of tracking the gaze, which is also known from the prior art and may either be based on either the orientation of the headset or goggles within the mesh produced. A gyroscope could be used but is generally not necessary and the techniques are known to a person skilled in the art.

The interface executed by the processor of the visual interaction device (DI), is configured to detect when the user's gaze is directed toward the ground. This means an orientation with a determined angle relative to the horizontal or vertical, with a gaze directed toward the portion of the mesh detected as being the ground on which the user is resting and in proximity thereto, for example, near the feet and/or with reference to the user's support polygon.

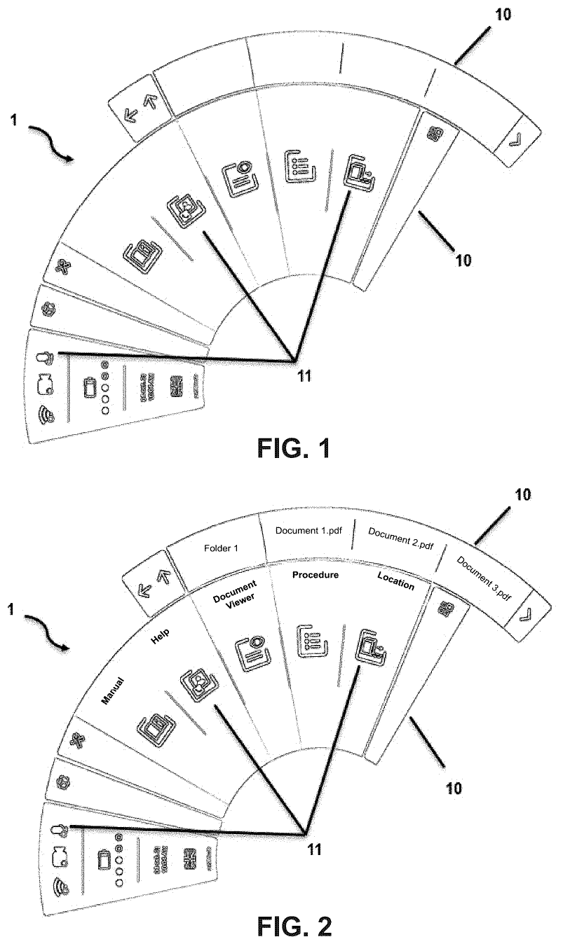

The interface executed by the processor of the visual interaction device (DI) is also configured to start, following the detection of the case where the user's gaze is oriented toward the floor, a launcher (1) presented to the user via the interaction device (DI) in the form of at least one navigation content item. This navigation content item is “projected” onto a medium to which the user has directed his gaze, preferably the floor. The term “projected” is used here to indicate that the content is displayed as if it was resting on the medium, even if it is actually being displayed on the interaction device The ground is an advantageous support for the reliability of the display, since it is generally more homogeneous, for example, with less contrasting details than the rest of the environment and often less subject to light exposure differences. The ground also has the advantage of being easy to detect and the calculations to detect it and to display the content thereupon are faster. However, it is possible to use other supports to project the navigation content item of the interface. For example, in particular, in the collaborative modes described later in the present application, it is possible to display the navigation content item, for example, with a reduced size compared to that generally displayed on the floor, on a surface, such as a table, for example, and in particular, the same surface on which the simulation is projected, which is the subject of the meeting in the collaborative mode. In this way, with the menu displayed on the same surface, users can move more easily between the features offered in the simulation and those provided for navigation, requiring less movement for the user's gaze. FIGS. 2 and 2 illustrate a launcher (1) according to one embodiment of the disclosure with various content items. A content item comprises a plurality of graphical elements (11), as shown in FIGS. 1 and 2, that the user can scroll through with their gaze and that are representative of a function to which they correspond. The interface detects the movement of the user's gaze on these graphical elements (11).

The interaction device is configured to perform visual feedback by highlighting (for example, with an overlay) the viewing area (for example, by highlighting the gaze area or the gazed-at graphical element) or by displaying a pointer (for example, by emitting a bright point) showing the user's gaze. This visual feedback allows the user to easily orient their gaze relative to the graphical elements (11) and to more easily select the functions of the graphical elements by viewing the fixing of their gaze in space.

Advantageously, the person skilled in the art will understand that the visual feedback of the interaction device improves the accuracy of the gaze and the ergonomics for the user, who obtains a physically perceptible feedback from their actions, which is consequently accompanied by saved time.

When the user's gaze comes to rest on one of these graphical elements (11) for a determined duration, the launcher (1) selects this graphical element (11) and triggers the function to which it corresponds, all of the functions available comprising at least:
a) the execution of an application available via the interface and executable on the interaction device (DI),
b) the opening of at least one content item or document stored in storage means accessible via the interface,
c) the deployment of other graphical elements (11) in the launcher (1), across which the user can move their gaze in order to trigger the same functions a), b) or c) when it comes to rest thereupon for the determined duration.

The determined duration, corresponding to the duration for which the user's gaze has been resting on a graphical element (11), is generally predetermined and optimized for all users. Nevertheless, in certain embodiments, it may be configurable by the user as a function of their navigation speed. The determined duration is generally of the order of 100 ms to 2 s and preferably of 500 ms. The values of the determined duration, which are considered to be representative of immobility, make it possible to validate a selection. Thus, the user knows how long they are enough to fix their gaze in order to launch a function and can, therefore, move in a fluid and rapid manner on the graphical elements available under their gaze.

It will also be noted that the parameters relating to the various functions available via the executed interface are configurable via the interface, by virtue of a graphical element (11) of the “configuration” or “adjustment” type, with, for example, a corresponding logo or icon such as those conventionally used.

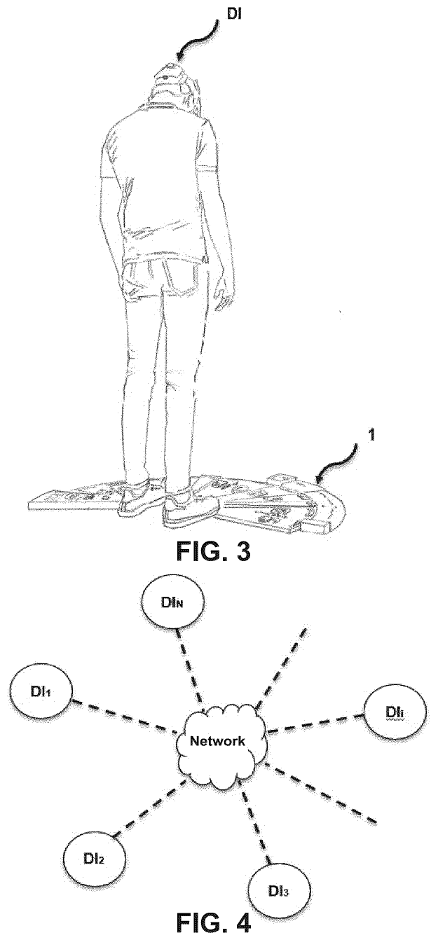

In certain embodiments, the navigation content item, comprising the plurality of graphical elements (11), comprises at least one ring (10) displayed on the ground and centered around the user as shown in FIG. 3, more specifically around their support polygon and in their visual field following their gaze toward the ground, the plurality of graphical elements (11) being distributed angularly on the ring (10), one next to the other.

When the user is immobilized on a graphical element (11) corresponding to a deployment function c), within a navigation content item, called a parent content item (first ring on FIGS. 1 and 2, starting from the bottom upwards), the launcher (1) displays another navigation content item, called a child content item (second ring on FIGS. 1 and 2). The child content item depends on the parent content item and comprises a ring (10) (or second ring (10)), preferably concentric to the ring (10) of the parent content (or first ring (10)), or a line, preferably radial to the first ring (10) gear. The child content item comprises at least one other graphical element (11) also corresponding to one of the functions a), b) or c), optionally with a plurality of repetitions of parent-child navigation content items of successive generations.

In the case where it is a line that is deployed, this generally means the end of the deployment options, unless the graphical elements (11) that it contains do not allow deployment by parallel or perpendicular lines or by a new ring (10), so that the user does not get lost in the tree provided by the interface. Their navigation will then remain fluid, intuitive, ergonomic, clear and easy.

Thus, navigation fluidity is achieved, which makes the interface, executed by the processor of the visual interaction device (DI), perfectly ergonomic, in particular, in the case of contextual content as will be seen below.

The disclosure, therefore, has the advantage of ergonomics but also of adaptive setting depending on the use that the user wishes to make of the system according to the disclosure. The applicant has been able to observe that the scanning of the gaze within concentric rings (10) is totally intuitive and particularly advantageous in terms of fluidity and efficiency.

The fact that the interface detects a gaze directed towards the ground, accelerates the process of detection by the computerized means, since the ground is a stable location relative to the user regardless of their position in a given environment and is less sensitive to problems associated with exposure to the sun or other phenomena that can interfere with the detection of the action that the user wishes to make. Indeed, a lost user will tend to look at their feet or raise their eyes to the sky but, in the latter case, he would then encounter problems linked to high exposure to light and a lack of contrast of the virtual content displayed on the interaction device (DI).

When the user is scrolling through a child navigation content item without coming to rest on one of the graphical elements (11) that it contains and moves their gaze to a parent navigation content item on which it depends, potentially across a plurality of parent-child generations, the launcher (1), after a determined time period, called the withdrawal period, withdraws the child content item(s) by canceling their display(s) on the interaction device (DI) and displays only the parent navigation content item on which the user is fixing their gaze.

This withdrawal period may be of the same order of magnitude as the immobilization time, preferably. This determined period or duration(e) is of the order of 100 ms to 2 s and preferably, 500 ms. In addition, in some embodiments, the graphical elements comprise elements, therefore the function is the withdrawal of the menu wherein they are located. There is then no need for this period, but it may be present anyway, so that it is sufficient to gaze upon a withdrawal graphical element or to divert the gaze to achieve the withdrawal.

As for the immobilization time, some embodiments provides that the interaction device (DI) is configured to allow the user to set the withdrawal period (via the interface, by virtue of a “configuration” or “adjustment” graphical element (11), with, for example, a corresponding logo or icon such as those conventionally used). The user can thus choose for how long the content items remain displayed, in particular, if they want to be able to return to a child content item more quickly without having to gaze the deployment element that leads to it again.

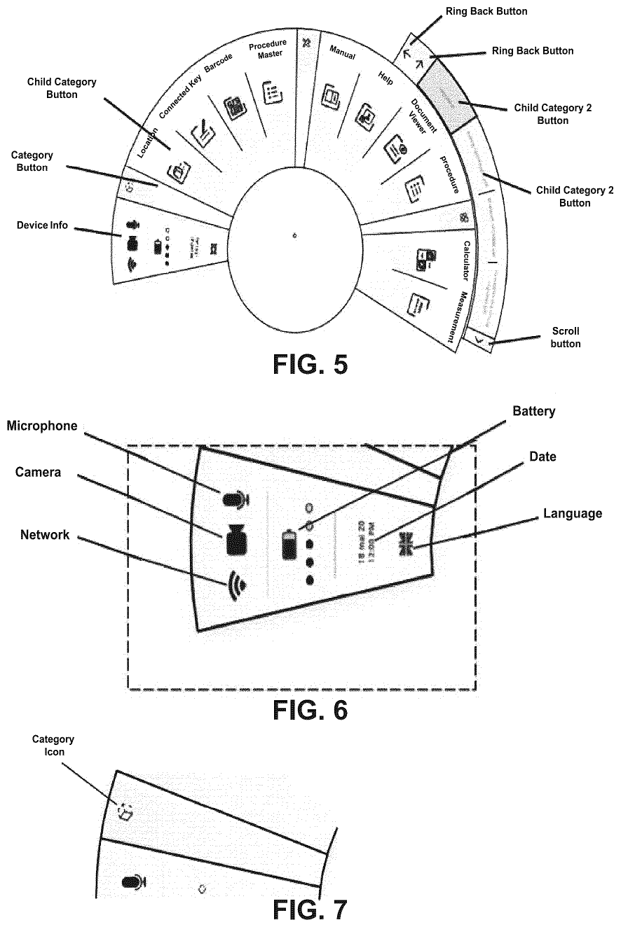

Various illustrative and non-limiting examples of the launcher (1) will now be described in a little detail, in particular, with regard to the possible forms of presentation, navigation, and features. FIGS. 5 to 12B illustrate an example of the launcher (or “Tools launcher,” in the form of a menu for launching tools and applications or opening content). As mentioned above, the launcher can be formed by rings of a plurality of levels. Each ring contains buttons (here shown by segments formed by an arc) of specific color, thickness and angle as shown in FIG. 5, each button will have specific effects or functions that will be described later in the present application.

In the illustrative and non-limiting example shown in FIG. 5, the first ring (corresponding to a parent content item) contains the Device Info and a plurality of Button Categories, which in turn contain a plurality of Child Button Categories. The second ring (which corresponds to the child content item) contains the resultant of the Child Category buttons of the first ring. The resultant is composed of several Child Category 2 buttons, a Ring Back button, a Ring Up Button, and two Scroll Buttons.

Interaction: All interactions, whether for the launcher or for the buttons in the launcher, take place depending on our gaze (the user's line of sight). Thus, as described above, looking down at their feet makes it possible to display the launcher (Launcher Tools) at the floor and the file. Likewise, diverting their gaze hides the launcher and makes us track it in position and in rotation.

The device information (the “device info”), in the illustrative and non-limiting example of FIG. 6 is a segment formed by an arc, of an angle of between 10° and 25°, of the first ring or parent content item. It has a thickness, for example, between 0.5 cm and 4 cm and is 90 degrees to the left of the user, the ring being centered around the user as described above. This segment is separated into a plurality of parts by horizontal strips. The top portion contains system icons: Microphone, Camera and Network. The middle contains a refillable battery icon and circles that represent the battery level as a percentage. A filled circle is equal to x % of battery. The bottom part contains the current date and time and the language in the form of a flag. The features associated with the different icons are:
Network: Icon that represents the status of connection to the Wifi network
Camera: Icon that shows if the camera is turned on/off
Microphone: Icon shows if the microphone is turned on/off
Date: Text that describes the current date in the “day in two-digit encryption/months” format, the last two digits of the year, and the current time in the “hour/minutes AM or PM” format
Language: Icon as a current language flag. The language can change. It switches all the texts from the menu to the selected language.

The category button, as in the illustrative and non-limiting example of FIG. 7, is a segment formed by an arc of circle, an angle of between 5° and 10°, of the first ring. It has a thickness, for example, between 0.5 cm and 4 cm. It contains an icon on the top of the segment that describes the category type. The functionalities or effects of the category button are to show/hide the apps or tools of the category selected from several categories such as: Application, “Tools,” “Widgets,” Test.

Interaction: To interact with the Category button, the user must keep the cursor linked to their head, that is to say fix their gaze, on this button for less than a second to select it.

Opening animation: The Child Category buttons, which represent the Applications/Tools related to the selected category, will be fanned out. This fanning-out takes about one second. During this fanning-out, the icons and texts of the Child Category buttons will become more opaque, becoming 100% opaque once the fanning-out is finished.

Closing animation: The Child Category buttons, which represent the Applications/Tools related to the selected category, will be fanned back in. This fanning-in takes about one second. During this fanning-in, the icons and texts of the Child Category buttons will become more transparent, becoming 100% transparent once the fanning-in is finished.

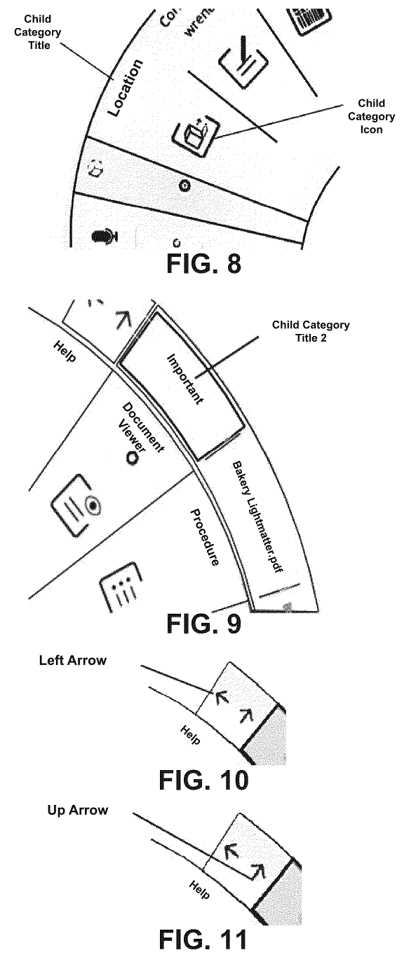

The child category button is a segment formed of an arc of circle, of an angle of between 10° and 25°, of the first ring, as in the illustrative and non-limiting example of FIG. 8. It has a thickness, for example, between 0.5 cm and 4 cm. It contains the title of an application on the top part of the segment and an icon in the middle of the segment. Each segment is separated by a strip The child category button (effect or features) launches an application or opens a second ring containing files that launch in the selected application.

Interaction: To interact with the Child Category button, the user must keep the cursor tied to the head, that is to say fix their gaze, on this button for less than a second to select it, and then rest on that button for about one second to validate the selection.

Selection validation animation: The Child Category button becomes filled from the inside of the circle out. It takes about one second to fill it 100%. The filling stops if this child category button is no longer being gazed at. The filling is reset if another child category button is gazed at.

As for the child category 2 button, this is a segment formed of an arc, of an angle of between 10° and 25°, of the second ring, as in the illustrative and non-limiting example of FIG. 9. It has a thickness, for example, between 0.5 cm and 4 cm to represent the folders and files. It contains a rounded title for the folder and file. As an effect or feature. If it is a white Child Category 2 button that is selected, this opens a file linked to the application. If, however, it is a yellow Child Category 2 button that is selected, it opens a folder.

Interaction: To interact with the Child Category 2 button, the user must keep the cursor linked to their head, that is to say fix their gaze, on this button for less than a second to select it.

The Ring Back button is a segment formed of an arc, of an angle of between 2° and 5° of the second ring as in the illustrative and non-limiting example of FIG. 10. It has a thickness, for example, between 0.5 cm and 4 cm. It contains a left arrow. The Ring Back button (effect or feature) makes it possible to return to the open folder preceding the one currently open.

Interaction: To interact with the Ring Back button, the user must keep the cursor linked to their head on this button, that is to say fix their gaze, for about a second to select it.

The Ring Up button is, for its part, a segment formed of an are, of an angle of between 2° and 5°, of the second ring, as in the illustrative and non-limiting example of FIG. 11. It has a thickness, for example, between 0.5 cm and 4 cm. It contains an up arrow. The Ring Up button (effect or feature) makes it possible to go back into the preceding folder hierarchically.

Interaction: To interact with the Ring Up button, the user must keep the cursor linked to their head, that is to say fix their gaze, on this button for less than a second to select it

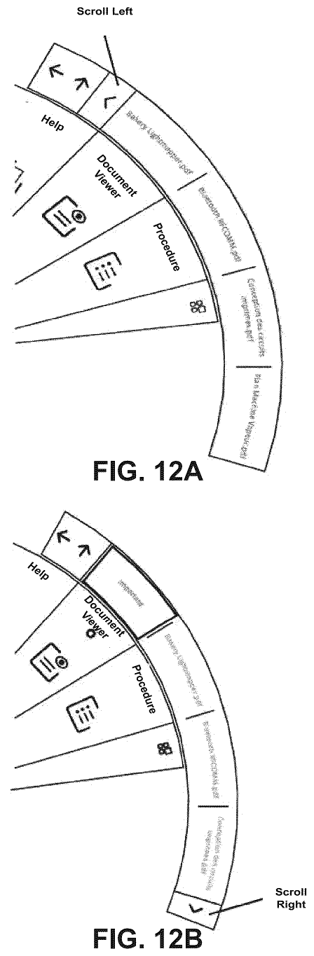

The Scroll button is a segment formed of a arc, of an angle between 2° and 5°, of the second ring (or child content item). It has a thickness, for example, between 0.5 cm and 4 cm. It contains an arrow to the left or the right as shown in a non-limiting manner respectively on FIGS. 12A and 12B, the scrolling button (effect or feature) makes it possible to scroll through the folders or files in the second ring as only four folders or files can be displayed. It is possible to scroll to the left or right. Scrolling to the right displays objects lower in the hierarchy, and scrolling to the left displays objects higher in the hierarchy.

Interaction: To interact with the Scroll button, the user must keep the cursor linked to their head, that is to say fix their gaze, on this button. This causes the second ring to scroll. Not looking at it stops it from scrolling.

Possible Animation or actions: Gazing at right-scrolling will scroll through the Child Category 2 buttons counter-clockwise. Gazing at left-scrolling will scroll through the Child Category 2 buttons clockwise. It takes about a second for a Child Category 2 button to travel to the next or previous Child Category 2 button. If the start or end of the scrolling is reached, the scroll button will be hidden. The Ring Back and Ring Up buttons stick to the first Child Category 2 button of the second ring if the left scroll button is hidden.

In some embodiments, the interaction device (DI) is configured to authorize the user to adjust the sensors (cameras, microphones, etc.).

Advantageously, the skilled person will understand that embodiments of the disclosure as described also enables a saving of hardware or computing resources required to allow the user to effectively interact with the interaction device (DI). Indeed, the selection and actuation of a graphical element (11) of the interface does not require a movement of the head toward the (targeted) element followed by a movement of the hand pointing towards the element and a gesture of the finger for the selection of the element as can be observed in certain systems or interaction devices (DI). Such systems may require the use of additional computing or hardware resources such as, for example, and in a non-limiting manner, gesture recognition devices or programs in order to interpret each gesture of the user's hand. In addition to being ergonomic by facilitating navigation, embodiments of the present disclosure are, therefore, also economical.

In some embodiments, the interface executed by the processor of the visual interaction device (DI) can propose to the user, via the launcher (1), navigation content items that are contextual, taking into account the environment of the user and/or a context wherein the user is located.

The context can be determined by the interface by virtue of the interaction device (DI) or any other device carried by the user and connected to the interface, providing it with information used by the interface, among them at least
receiving images captured by the interaction device (DI), optionally with image recognition and/or detection of electronic codes (barcode, QR codes, etc.)
geolocation
detecting various physical values by various types of sensors (pressure sensors, temperature sensors, etc.)
receiving information provided by connected objects present in the environment of the user and able to communicate with the computerized means executing the interface.

The interaction device (DI) is configured for visual recognition of an environment or objects present in a given environment. The interaction device (DI) thus comprises at least programs/algorithms and machine learning models whose execution on the processor of the device makes it possible to implement the visual and/or sound recognition features based on images captured by the sensors of the interaction device (DI) and/or data loaded into the memory of the interaction device (DI).

In some embodiments, the interaction device (DI) can further be configured for voice or sound recognition via the execution of programs/algorithms and machine learning models.

In some embodiments, the interaction device (DI) can also be configured to automatically translate the information presented to the user via the interface in a language they can understand by executing a program/algorithm or a machine learning model based on the user's navigation content history and/or the voice recognition of the user and/or on data loaded into the memory of the interaction device (DI).

Advantageously, the system as described and, in particular, the interaction device (DI) is adapted to assist in maintenance by guiding the user step-by-step via the interface through the actions to be carried out and, to check after each action by the user whether or not the action was correctly carried out. If the action has not been correctly carried out, the device is configured to notify the user via the interface so that the user can repeat the action.

A person skilled in the art will thus understand that the device may comprise computerized means (programs, devices, etc.) adapted to analyze the physical effects resulting from the user's actions, on the basis of data captured by the sensors of the device and/or data loaded into memory. For example, and in a non-limiting manner, when the instruction communicated by the device to the user comprises moving an object in the real environment, the analysis may consist in comparing the captured positions of the object before the instruction was communicated and after a determined period of time, or feedback to the user via the interface to confirm the movement of the object.

In another example relating to a broken meter, the interaction device (DI) can guide the user in starting a broken meter. The interaction device (DI) can be configured to visually guide (for example, displaying light arrows on the ground) the user to the location where the meter is located. It is understood that 3D map data of the real environment can be loaded into memory with the determined location of the meter. The device based on this mapping and the visual recognition feature will guide the user to the position of the counter. Through visual recognition, the device can determine the type of meter and load into memory the characteristics relating to the meter and to its maintenance in case of failure. The user can then be guided through maintenance based on this information.

The disclosure thus makes it possible to simplify the user's access to various types of information, via the interaction device (DI), optionally selected beforehand to determine the functions corresponding to the graphical elements (11) that will be presented to them in a given environment, as well as other information in other environments, depending on their preferences, recorded in storage means accessible to the computerized means executing the interface.

In some embodiments, the interface executed by the processor of the visual interaction device (DI) is configured to define at least one list of applications and/or content items or documents to be displayed, in particular, as a function of the environment wherein the user is located, the list of applications and/or content items or documents potentially being updated when requested by the user via the selection of a dedicated graphical element (11) when they are not part of the selection displayed by the interface, in order to obtain a wider set of functions, the interaction device (DI) then loading into memory the data necessary for this update.

For example and in a non-limiting manner, a user located near the Notre Dame building would be shown, via the interface, that building as it would have appeared, for example, in 1712 with moving scenes corresponding to the era, or in architectural mode. The device can also load into memory the information relating to the building and present it to the user. In another example, the user could also be near a machine in a factory. In this case, the interface could display the machine's model and technical features.

Advantageously, the person skilled in the art will understand that the system as described is configured to dynamically adapt the virtual environment and the content of the information displayed as a function of the external real environment and/or data from the sensors of the interaction device (DI) loaded into memory (optionally for visual recognition).

In another alternative, the interaction device (DI) can be configured to allow the user to personalize the interface by defining at least:
a list of applications and/or content items or documents that they want to see, in particular, depending on the environment where they are; and
a list of applications and/or content items or documents for which they can request updates when they are not part of the user's current selection, in order to obtain a wider set of functions, the interaction device (DI) then downloading the data necessary for this update.

In some embodiments, the visual interaction device (DI) can be configured to monitor the operation of a machine or device, the interface executed by the processor of the visual interaction device (DI) being adapted to display information relating to the operation of the machine or of the device. Thus, in the implementation of the monitoring process, the processor of the device can be configured to communicate directly with sensors arranged on the machine or device to be monitored and a database containing at least information relating to the internal and external structure of the machine or of the device. In another variant, the information concerning the structure of the machine or of the device is pre-recorded in a memory of the computing system of the interaction device (DI) and accessible to the processor.

The sensors can be arranged so as to provide measurements of parameters that the user wishes to monitor. For example, and in a non-limiting manner, this parameter may be the temperature of the machine or device, or of a specific component of the machine or device such as a motor. The parameter may also be the electrical current in an electronic circuit of the machine or device, etc.

The processor of the visual interaction device (DI) is configured to:
retrieve or receive the information about the structure of the machine or device to be monitored stored in the database or in the memory of the computer system of the visual interaction device (DI),
building, by executing a program, an external and internal 3D representation of the machine or device to be monitored from the retrieved or received information; and
displaying, via the executed interface, the external and internal 3D structure of the machine or device to be monitored with the location of each sensor.

The values of the parameters measured by the sensors are transmitted in real time, at the same time as the position of the sensors, to the visual interaction device (DI), and communicated to the user via the executed interface. Thus, if abnormal replacement values are measured, the anomaly is automatically detected.

Advantageously, the person skilled in the art will understand that the system as described makes it possible to effectively improve the maintenance of machines or devices and also to save time in the event of a breakdown. Indeed, detecting an anomaly and displaying it via the executed interface of the visual interaction device (DI) makes it possible to know exactly the location of the anomaly that corresponds to the positioning of the sensor that measured this anomaly. Thus, this information can allow the user to effectively and rapidly repair the anomaly while reducing the number of hardware resources needed for the maintenance of the machine.

In some embodiments, the processor of the visual interaction device (DI) is configured to actuate a device connected via the executed interface. The interface comprises at least one graphical element (11) whose actuation sends a signal to the processor of the device, which activates a signal transmission device arranged on the visual interaction device (DI). The signal transmission device emits an activation signal comprising at least activation instructions in the direction of the connected device, the connected device being configured to recognize, via a protocol that can be secure, the activation signal emitted, recording it in memory and executing on a processor the activation instructions to activate itself.

In some embodiments, the interaction device (DI) is configured to update the interface, with the user's selection of an element dedicated to this update triggering the connection and synchronization of the interaction device (DI) to computerized means containing a set of parameters, applications, content items or documents loadable into memory (by downloading, saving, etc.) by the interaction device (DI) in order to render the latter and the interface compatible with the immediate needs of the user.

The interaction device (DI) is configured to synchronize the data relating to actions carried out by a user, via the interface, with a plurality of interaction devices (DI) of other users to which the interaction device (DI) is connected via a network.

In some embodiments, the system comprises a plurality of interaction devices (DI) connected to each other, preferably securely to form a shared device cluster. At least one of these interaction devices (DI) generating content items to be displayed on the other interaction devices (DI) is configured to share, by transmission, instructions relating to content items to be displayed on the interface of the other devices as a function of the actions carried out via the interface, so that all of the interaction devices (DI) display the same elements as a result of actions or selections carried out via the interface of the interaction device (DI).

Thus, when a plurality of devices are connected together via a network, as shown in FIG. 4, the action carried out by one of the users via the interface of its interaction device (DI) is automatically reproduced for the other users without their having to intervene. For example and in a non-limiting manner, in the case of a three-dimensional representation of a real environment (or a machine, an object, a factory, etc.), shared between N interaction devices (DI), which are collaborating (DI₁, DI₂, . . . , DI_{N}) via their respective interfaces, when a user who has an interaction device (DIᵢ) (i=1, N) moves, for example, an object in the environment shown, via its interface, from a location PA to a location PB, the position of the moved object is updated in the visual field of the other users in possession of the other interaction devices DI₁, . . . , DI_{(i-1),} Di(i+1), . . . ₍ᵢ₊₁₎, . . . . DI_{N}, which collaborate with the interaction device (Diᵢ) that originated the action

Thus, it will be understood that each interaction device (DI) is configured to transmit instructions or programs relating to actions and/or content items to other interaction devices (DI) with which it communicates in a network, such that the execution of the instructions or the programs on the processors of the other devices controls them to update the environment displayed via their respective interfaces or to reproduce, synchronously, the actions carried out via the interface of the interaction device (DI) that transmitted the instructions or codes.

The disclosure also relates to a method of interaction between a user and computerized means by virtue of a visual interaction device (DI).

In certain embodiments, the method comprises executing, on the computerized means, a human-machine interface of a system as described in the present application.

In some embodiments, the human-machine interface system comprises a plurality of visual interaction devices (DI) each comprising image-capturing means and display means and computerized means comprising at least one processor executing an interface for a user to interact with the visual interaction device (DI). The system can present to the user an at least partially virtual content item, in particular, for virtual reality and/or augmented reality. The interaction device (DI) captures, via its image-capturing means, the real environment of the user to provide it to the interface. That interface comprises means or elements for automatic actuation of the processor of the interaction device (DI) that, by executing a program, generates a mesh of the real environment on the basis of the captured images. The interface is configured to track the user's gaze in the generated mesh (which serves as a basis for the creation of the virtual environment). The interface is configured to connect to each of the users' visual interaction devices (DI) to allow them to share data between them via the computerized means of the interaction device (DI) and to display content items thereof, which are synchronized on the various securely communicating visual interaction devices (DI) (for example, users participating in a private meeting) The system comprises means for storing data containing objects, documents and 3D mappings (virtual environments established from real environments and representative of maps of real sites or places previously recorded with various levels of detail on their topography and/or their geolocation and/or various technical information relating to the physical elements present in these sites or locations). The interface is also configured to track the actions of each of the users in a virtual environment thus presented to the users of the communicating devices (for example, users participating in the private meeting) to whom the interface proposes a set of content items, objects or documents that can be shared with the users, so that the tracking of their respective actions allows them to place these various content items, objects or documents within the virtual environment. Preferably, the system is also configured to connect to at least one sensor or device communicating by a user (or a server) present within the real environment thus simulated in order to provide at the interface, in real time or as a prediction according to a schedule, information relating to the physical parameters measured in real time in the real environment or predicted for a later time or date, in order to provide the users of the communicating devices (for example, users participating in the private meeting) with the actual physical information present or predictable within the real environment. The disclosure can, therefore, also relate to such a collaborative system of a plurality of visual interaction devices (DI), whether or not it integrates the gaze-tracking interface described in the present application.

Advantageously, the skilled person will understand that the system thus described is configured for remote collaboration and data sharing between an interaction device (DI) and other devices that can be directly present in the same external real environment as the interaction device (DI) or distant therefrom, in a separate environment.

The interface provides to the users, on the one hand, a set of content items, objects or documents that are selected according to a defined context, such as, for example, that of an intervention by law enforcement or armed forces, on a site or place threatened by an attack, with, furthermore, a set of law enforcement or armed forces members available, available weaponry and/or protection, with possibly a timeframe for their availability and deployment in the real environment.

The present application describes various technical features and various advantages with reference to the figures and/or various embodiments. Those skilled in the art will understand that the technical features of a given embodiment may be combined with features of another embodiment, unless explicitly stated otherwise, or if it is obvious that these features are incompatible or that the combination does not provide a solution to at least one of the technical problems stated in this application. Furthermore, the technical features described in a given embodiment may be taken individually from the other technical features of this embodiment unless explicitly stated otherwise.

It should be obvious to those skilled in the art that the present disclosure allows embodiments in numerous other specific forms without departing from the scope of the invention as defined by the appended claims.

1. A human-machine interface system, comprising at least one visual interaction device (DI), comprising an image capture device, a display, and at least one processor running an interface for user interaction with the at least one visual interaction device (DI), the system presenting the user with an at least partially virtual content item, in particular, for augmented reality, the at least one visual interaction device (DI) capturing a real environment of the user in order to provide it to the interface, which generates a mesh of the real environment and tracks the user's gaze, the interface being characterized in that it is configured to detect when the user's gaze is oriented toward the ground and, following this detection, to start a launcher that is presented to the user via the at least one visual interaction device (DI) in a form of at least one navigation content item comprising a plurality of graphical elements that the user is able to scroll through with their gaze and that are representative of a function to which they correspond, the interface detecting movement of the user's gaze across the plurality of graphical elements, and, when the user's gaze has come to rest on one of the plurality of graphical elements for a given duration, the launcher selects the plurality of graphical and triggers the function to which it corresponds, a set of available functions comprising at least:
a) execution of an application available via the interface and executable on-said the at least one visual interaction device (DI);
b) opening of at least one content item or document stored in a non-transitory computer-readable storage device accessible via the interface; and
c) deployment of other graphical elements in the launcher, across which the user can move their gaze in order to trigger the same functions a), b) or c) when it comes to rest thereupon for the given duration.

2. The system according to claim 1, wherein the navigation content item, comprising the plurality of graphical elements, comprises at least one ring displayed on the ground and centered around the user, the plurality of graphical elements being distributed angularly on the at least one ring, one next to the other.

3. The system according to claim 2, wherein, when the user has come to rest on a graphical element corresponding to a deployment function c), within a navigation content item, called a parent, the launcher displays another navigation content item, called a child, dependent on the parent content item and comprising a second ring, concentric to the at least one ring, or a line, radial to the at least one ring, and comprising at least one other graphical element also corresponding to one of the functions a), b) or c), with a plurality of repetitions of parent-child navigation content items of successive generations.

4. The system according to claim 3, wherein, when the user is scrolling through a child navigation content item without coming to rest on one of the graphical elements that it contains and moves their gaze to a parent navigation content item on which it depends, potentially across a plurality of parent-child generations, the launcher, after a determined time period, withdraws the child navigation content item(s) by canceling their display(s) on the at least one visual interaction device (DI) and displays only the parent navigation content item on which the user is fixing their gaze.

5. The system according to claim 1, wherein the interface proposes to the user, via the launcher, navigation content items that are contextual, taking into account the real environment of the user and/or a context wherein the user is located, the interface determining the context by virtue of the at least one visual interaction device (DI) or any other device carried by the user and connected to the interface, providing it with information used by the interface, among them at least:
receiving images captured by the at least one visual interaction device (DI), optionally with image recognition and/or detection of electronic codes (barcode, QR codes, etc.);
geolocation;
detecting various physical values by various types of sensors; and
receiving information provided by connected objects present in the real environment of the user and able to communicate with the at least one processor executing the interface.

6. A system according to claim 5, wherein the interface is configured to define at least one list of applications and/or content items or documents to be displayed, in particular, as a function of the real environment wherein the user is located, the list of applications and/or content items or documents potentially being updated on request from the user via the selection of a dedicated graphical element when they are not part of the selection displayed by the interface, in order to obtain a wider set of functions, the at least one visual interaction device (DI) then loading in memory the data necessary for this update.

7. A system according to claim 6, wherein the at least one visual interaction device (DI) is configured to update the interface, with the user's selection of an element dedicated to this update triggering connection and synchronization of the at least one visual interaction device (DI) to the at least one processor containing a set of parameters, applications, content items or documents loadable into memory by the at least one visual interaction device (DI) in order to render the at least one visual interaction device and the interface compatible with the immediate needs of the user.

8. A system according to claim 7, wherein the system comprises a plurality of interaction devices (DI) connected to each other, preferably securely to form a shared device cluster, at least one of the plurality of interaction devices (DI) being configured to share by transmission instructions relating to content items to be displayed on the interface of the any other device depending on actions carried out via the interface, so that all of the plurality of interaction devices (DI) display the same elements as a result of actions or selections performed via the interface of the at least one of the plurality of interaction devices (DI).

9. A method comprising executing a human machine interface via the human machine interface system of claim 1.

10. The human-machine interface system according to claim 8, wherein the plurality of visual interaction devices (DI) each comprises an image capture device, a display, and at least one processor running an interface for user interaction with the plurality of visual interaction devices (DI), the system presenting the user with an at least partially virtual content item, in particular, for virtual reality and/or augmented reality, the plurality of visual interaction devices (DI) capturing the real environment of the user in order to provide it to the interface, which generates a mesh of the real environment and tracks the user's gaze, the interface being connected to each of the users' visual interaction devices (DI) to enable them to share data with each other via the at least one processor and display content to them, which is synchronized on various securely communicating visual interaction devices (DI), the system comprising a non-transitory computer-readable storage device containing objects, documents and 3D maps (maps of virtual environments established from real environments and representative of maps of real sites or places previously recorded with various levels of detail as to their topography and/or their geolocation and/or various technical information relating to physical elements present in these sites or places), the interface being configured to track actions of each of the users in the virtual environment thus presented to the users of the communicating visual interaction devices to which the interface proposes a set of content items, objects, or documents sharable with the users, so that the tracking of their respective actions enables them to place these various content items, objects or documents within the virtual environment, the system also being connected to at least one sensor or communicating visual interaction device of a user present within the real environment thus simulated in order to provide the interface, in real time or predicted according to a schedule, with information relating to physical parameters measured in real time in the real environment or predicted for a later time or date, in order to provide the users of the communicating devices with the actual physical information present or predictable within the real environment.

11. A human-machine interface system comprising:
at least one visual interaction device comprising:
an image capture device;
a display; and
at least one processor executing an interface for a user to interact with the at least one visual interaction device,
wherein the system presents the user with an at least partially virtual content item,
wherein the at least one visual interaction device is configured to:
capture an environment of the user to provide the environment to the interface, the interface configured to:
generate a virtual mesh based, at least in part, on the environment;
track a gaze of the user;
detect when the gaze of the user is oriented toward a ground area of the environment; and
start a launcher that is presented to the user via the at least one visual interaction device, the launcher in the form of at least one navigation content item comprising a plurality of graphical elements that the user is able to scroll through responsive to the gaze of the user and that are representative of a function to which they correspond;
detect movement of the gaze of the user across the plurality of graphical elements;
select a graphical element of the plurality of graphical elements responsive to the gaze of the user resting on the graphical element for a pre-determined duration of time; and
trigger a function to which the selected graphical element corresponds the triggered function including one or more of a set of available functions comprising at least: execute an application available via the interface and executable on the at least one visual interaction device; open at least one content item or document stored in a non-transitory computer-readable storage device accessible via the interface; and deploy other graphical elements in the launcher across which the user can move their gaze to trigger one or more of the set of available functions when it comes to rest thereupon for the pre-determined duration of time.

12. The system of claim 1, wherein the navigation content item comprises at least one ring displayed on the ground and centered around the user, the plurality of graphical elements being distributed angularly on the at least one ring, one next to the other.

13. The system of claim 1, wherein, when the gaze of the user rests on a graphical element corresponding to the function to deploy other graphical elements in the launcher, within a first navigation item, display, via the launcher, a second navigation content item dependent on the first navigation item and comprising a second ring concentric to the at least one ring or a line radial to the at least one ring and comprising at least one other graphical element corresponding to the set of available functions.

14. The system of claim 3, wherein when the user scrolls through a child navigation content item dependent on another navigation content item without coming to rest on one of the graphical elements that it contains and moves the gaze to a parent navigation content item from which the child navigation content item depends, the launcher, after a pre-determined period of time, withdraws the child navigation content item by canceling the child content item's display on the at least one visual interaction device and displays only the parent navigation content item on which the gaze of the user is fixed.

15. The system of claim 1, wherein the interface generates, via the launcher, contextual navigation content items based, at least in part, the environment of the user and/or a context where the user is located, the interface to determine the context via the at least one visual interaction device or a separate device carried by the user and connected to the interface and providing the at least one visual interaction device or the separate device with information including:
images captured using the at least one visual interaction device;
geolocation data;
various physical values detected by various types of sensors; and
information provided by connected objects present in the environment of the user and able to communicate with the at least one processor executing the interface.

16. The system of claim 5, wherein the interface is configured to define at least one list of applications and/or content items or documents to be displayed as a function of the environment where the user is located, the list of applications and/or content items or documents being updated on request from the user via the selection of a dedicated graphical element when they are not part of the selection displayed by the interface to obtain a sider set of functions, responsive to the at least one visual interaction device loading update data in memory.

17. The system of claim 6, wherein the at least one visual interaction device is configured to update the interface with the user's selection of an element corresponding to an update triggering connection and synchronization of the at least one visual interaction device to the at least one processor, the at least one processor containing a set of parameters, applications, content items, or documents configured to load into memory via the at least one visual interaction device to render the at least one visual interaction device and the interface compatible with a need of the user.

18. The system of claim 7 wherein the system comprises a plurality of interaction devices securely connected to each other to form a shared device cluster, at least on of the plurality of interaction devices configured to share by transmission instructions relating to content items to be displayed on the interface of any other device depending on actions carried out via the interface such that each of the plurality of interaction devices display the same elements responsive to the actions or selections performed via the interface of the at least one of the plurality of interaction devices.

19. A method comprising:
tracking, via a visual interaction device, a gaze of a user;
capturing an environment of the user via the visual interaction device;
providing the environment to an interface of the visual interaction device;
generating a virtual mesh of the environment;
detecting when the gaze of the user is oriented past a pre-defined orientation boundary;
presenting a launcher comprising a plurality of graphical elements to the user via a display of the visual interaction device;
detecting when a gaze of the user comes to rest on one of the plurality of graphical elements for a pre-determined period of time; and
executing a pre-defined function responsive to the detection.

20. The method of claim 19, further comprising:
providing the interface with one or more images captured by the at least one visual interaction device using image recognition and/or detection of one or more electronic codes;
detecting a geolocation of a user;
detecting various physical characteristics of the environment of the user via one or more types of sensors; and
receiving information provided by objects in communication with the at least one processor executing the interface, the objects present in the environment of the user.
